(19) United States
(12) Patent Application Publication
(10) Pub. No.: US 2016/0350895 A1
(43) Pub. Date: Dec. 1, 2016

(54) TRANSLATION DEVICE

(71) Applicant: SHARP KABUSHIKI KAISHA, Sakai-shi, Osaka (JP)

(72) Inventors: Koichi YAMAGUCHI, Sakai-shi (JP); Hirokazu ISHIKAWA, Sakai-shi (JP); Seigoh SASAKI, Sakai-shi (JP)

(21) Appl. No.: 15/111,838

(22) PCT Filed: Aug. 19, 2014
(86) PCT No.: PCT/JP2014/071648

§ 371 Date: Jul. 15, 2016

(30) Foreign Application Priority Data
Feb. 12, 2014 (JP) 2014-024793

(51) Int. Cl. G06T 3/60; G06K 9/32

(52) U.S. Cl. CPC G06T 3/60; G06K 9/3258; G06K 2209/01

(57) ABSTRACT

A device including: a source string orientation deciding section (23) for deciding a source string orientation, the source string orientation being an orientation of a character string to be translated; a source string orientation display control section (24) for controlling a display section to display source string orientation information indicating the source string orientation; and a translation section (26) for translating characters as a character string having the source string orientation.

### TECHNICAL FIELD

The present invention relates to, for example, a translation device for recognizing a character contained in a captured image and translating recognized characters.

### BACKGROUND ART

In known techniques, a conventional mobile device recognizes, via optical character recognition (OCR), a character string contained in an image being captured, translates the character string, and displays a translated result. Furthermore, some conventional mobile devices are configured to determine whether a screen has a portrait orientation or a landscape orientation, and then indicate whether a current screen orientation is portrait or landscape. Further still, Patent Literature 1 discloses art for indicating that an image capture device is in an inclined state.

### CITATION LIST

### Patent Literature

### [Patent Literature 1]

Japanese Patent Application Publication Tokukai No. 2009-122628 (Publication date: Jun. 4, 2009)

### SUMMARY OF INVENTION

### Technical Problem

A translation becomes difficult in a case where (i) a device recognizes a character string contained in an image via OCR so as to translate the character string and (ii) an orientation of a character string which the device is attempting to translate differs from an orientation of an actual character string.

The following is a discussion of such a case with reference to FIG. 7. As mentioned above, some conventional mobile devices include a function for determining whether a screen of a mobile device has a portrait orientation or a landscape orientation. Assume a case where (i) the screen of the mobile device has a portrait orientation and (ii) an English character string is translated. As illustrated in (a) of FIG. 7, a character string to be translated is oriented such that it runs along the width of the mobile device. Similarly, in a case where the screen of the mobile device has a landscape orientation, the character string to be translated is oriented such that it runs along the length of the mobile device (see (b) of FIG. 7).

Consequently, in a case where a user cannot easily determine whether the screen of the mobile device has a portrait or landscape orientation, an orientation of a character string which the mobile device attempts to translate can differ from the orientation of the actual character string. For example, in a case where a book (leaflet) on a table is subject to image capture, the screen of the mobile device is parallel to the ground (see (c) of FIG. 7). This makes it difficult for the user to determine whether the screen has a portrait orientation or landscape orientation. This ultimately makes it difficult for the user to determine whether or not the orientation of a character string which the mobile device is attempting to translate matches the orientation of the actual character string.

Note that this kind of problem cannot be solved with the art disclosed in Patent literature 1.

The present invention has been made in view of the above problem. An object of the present invention lies in providing, for example, a translation device that allows a user to be aware of an orientation of a character string to be translated.

### Solution to Problem

In order to solve the above problem, a translation device according to one aspect of the present invention is a translation device for (i) recognizing a character contained in a captured image, (ii) translating one or more recognized characters, and (iii) displaying a translation on a display section, the translation device including: a source string orientation deciding section for deciding a source string orientation, the source string orientation being an orientation of a character string to be translated; a source string orientation display control section for controlling the display section to display source string orientation information indicating the source string orientation decided by the source string orientation deciding section; and a translation section for translating the one or more recognized characters as a character string having the source string orientation.

### Advantageous Effects of Invention

With the configuration of one aspect of the present invention, a user is provided with information indicating an orientation of a character string to be translated. This brings about the advantageous effect of allowing the user to be easily aware of the orientation in which the character string is to be translated.

### BRIEF DESCRIPTION OF DRAWINGS

FIG. 1 is a block diagram showing a configuration of a main part of a translation device according to an embodiment of the present invention.

FIG. 2 is a diagram illustrating an example of a screen of the translation device.

FIG. 3 is a flowchart showing how the translation device translates a character string.

FIG. 4 is a flowchart showing how the translation device translates a character string.

FIG. 5 is a flowchart showing how the translation device translates a character string.

FIG. 6 is a flowchart showing how the translation device translates a character string.

FIG. 7 is a diagram illustrating a problem that exists with prior art. (a) of FIG. 7 is a diagram showing an example of a screen having a portrait orientation. (b) of FIG. 7 is a diagram showing an example of a screen having a landscape orientation. (c) of FIG. 7 is a diagram showing a state in which it becomes difficult to distinguish between portrait and landscape orientation.

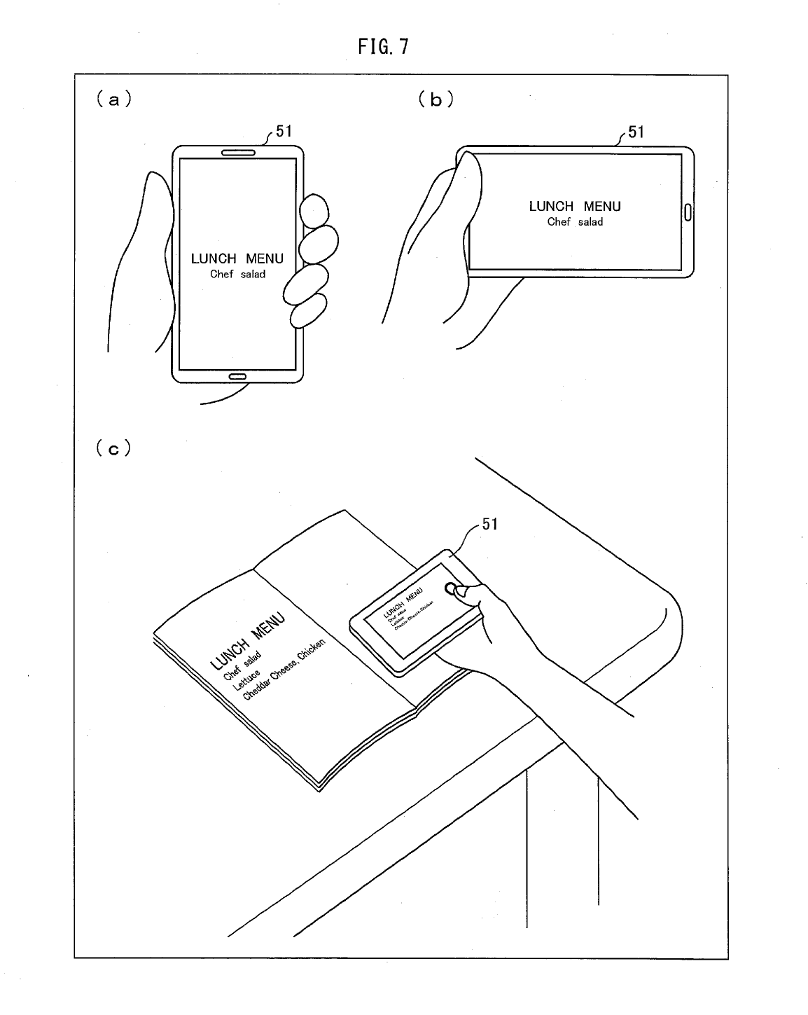

### DESCRIPTION OF EMBODIMENTS

### Embodiment 1

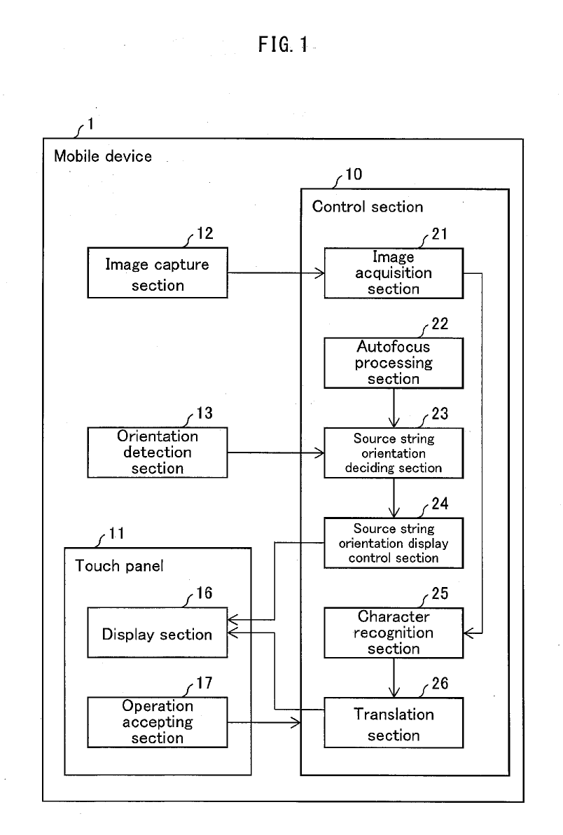

The following discusses Embodiment 1 of the present invention with reference to FIGS. 1 through 3. FIG. 1 is a block diagram showing a configuration of a main part of a mobile device 1 (translation device) in accordance with Embodiment 1. The mobile device 1 recognizes, via character recognition processing (optical character recognition, or OCR), a character string contained in an image which is being captured. The mobile device 1 then translates a character (string) thus obtained via the character recognition processing. Note, here, that during translation, a difference can arise between (i) an orientation of the character string obtained via the character recognition and (ii) an orientation of a character string to be translated (hereinafter also referred to as “source string orientation”). This makes it difficult to accurately translate a character (string). To address this kind of problem, a feature of the mobile device 1 resides in displaying, at a suitable time and position, information indicating the source string orientation. This enables the user to be easily aware of the source string orientation.

[Configuration of Mobile Device 1]

As shown in FIG. 1, the mobile device 1 includes a control section 10, a touch panel 11, an image capture section 12, and an orientation detection section 13.

The touch panel 11 includes a display section 16 and an operation accepting section 17 (input surface). The touch panel 11 accepts a touch or near-touch on the input surface, provides the control section 10 with information indicating a position of the touch or near-touch, and displays information provided by the control section 10.

The display section 16 displays information and can be realized, for example, by a liquid crystal display or an organic EL display. The operation accepting section 17 serves as a user interface for accepting an input operation conducted by a user. The operation accepting section 17 is provided such that it overlies a display screen of the display section 16.

The image capture section 12 is an image capture device (i.e., a camera) that captures an image of a subject. Note that examples of the image capture section 12 encompass (i) a device for capturing a still image such as a photograph, (ii) a device for capturing a video image such as a movie, and (iii) a device that captures both still and video images. The control section 10 controls the image capture section 12 to capture an image of a subject. The image capture section 12 supplies a captured still image and/or video image to an image acquisition section 21.

The orientation detection section 13 detects an orientation of the mobile device 1 and then provides a detection result to a source string orientation deciding section 23. Examples of the orientation detection section 13 encompass a geomagnetic sensor and a gyroscopic sensor.

The control section 10 carries out various processing in the mobile device 1, including character recognition processing for an obtained image and translation. The control section 10 includes the image acquisition section 21, an autofocus processing section 22, a source string orientation deciding section 23, a source string orientation display control section 24, a character recognition section 25 (subject angle determination section), and a translation section 26.

The image acquisition section 21 acquires an image via the image capture section 12 and sends the image thus obtained to the character recognition section 25.

The autofocus processing section 22 performs processing (autofocus processing) so that the image capture section 12 is in focus. Once autofocus processing has commenced, the autofocus processing section 22 provides notification of such to the source string orientation deciding section 23.

Upon receipt of a notification of the autofocus processing having commenced from the autofocus processing section 22, the source string orientation deciding section 23 decides a relation between (i) the orientation of the mobile device 1 and (ii) an orientation of a character string to be translated, with reference to an orientation of the mobile device 1 as notified by the orientation detection section 13. More specifically, in a case where English, whose character string is horizontally oriented, is to be translated into another language, an orientation along the width of the mobile device is decided to be the source string orientation while the mobile device 1 is displaying a portrait-orientation screen. Likewise, an orientation along the length of the mobile device is decided to be the source string orientation while the mobile device 1 is displaying a landscape-orientation screen. Here, given that the mobile device 1 has a rectangular display screen, “portrait-orientation screen” refers to a screen displayed in a case where a long side of the display screen is closer to vertical than is a short side of the display screen. Similarly, “landscape-orientation screen” refers to a screen displayed in a case where a short side of the display screen is closer to vertical than is a long side of the display screen.

The source string orientation display control section 24 controls the display section 16 to display, for a predetermined amount of time, information indicating the source string orientation as decided by the source string orientation deciding section 23. “Information indicating the source string orientation” refers to information indicating a relationship between the orientation of the mobile device 1 and both (i) a character orientation and (ii) a character string orientation.

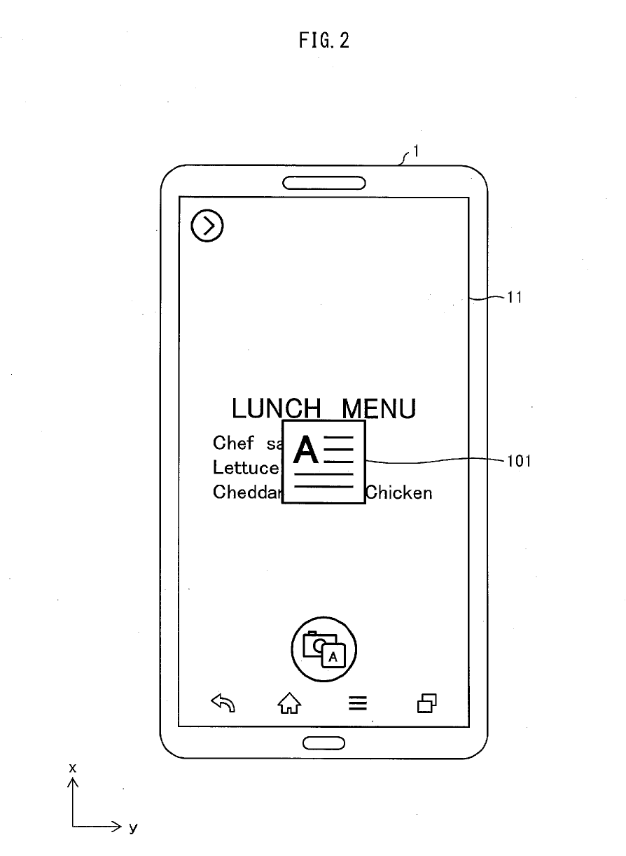

FIG. 2 illustrates an example of information indicating the source string orientation. FIG. 2 illustrates an example display screen of the mobile device 1. An icon 101 (source string orientation information) serves as the information indicating the source string orientation. In the icon 101, a letter “A” indicates the character orientation and a plurality of horizontal lines (horizontal bars) indicate the character string orientation. As such, the icon 101 indicates that (i) the character orientation is along the length of the display screen and (ii) a character string will be translated in an orientation along the width of the display screen. Note that the example of the icon 101 is non-limiting. Alternatively, the icon 101 can be any sort of displayed information that indicates the character orientation and the character string orientation in a recognizable manner. For example, the character orientation is not limited to being indicated by the letter “A” and can alternatively be indicated by a different alphabetic letter or a character of a different language. Furthermore, an arrow or some other symbol can be used instead of a linguistic character. Similarly, character string orientation is not limited to being indicated by lines, and can be alternatively indicated by an arrow, word, figure, or the like. Note also that the icon 101 can be semitransparent.

Note that the icon 101 is displayed near the character string to be translated, for example, substantially in the center of the display screen. This allows the user to clearly recognize the icon 101. This is because it is highly likely that the user is looking at the character string to be translated. As such, displaying the icon 101 near that character string increases the likelihood that the icon 101 will come into the user's view.

Note that the “predetermined amount of time” refers to an amount of time that allows the user to be aware of the icon 101 but is not so long that the user feels distracted by the icon 101. This amount of time can be, for example, approximately 1 second (0.5 seconds to 1.5 seconds).

The character recognition section 25 recognizes a character contained in an image acquired by the image acquisition section 21. The character is recognized via, for example, OCR. The character recognition section 25 then notifies the translation section 26 of a recognized result.

The translation section 26 translates the recognized result of which is notified by the character recognition section 25. Specifically, the translation section 26 translates, as a character string, characters lined up in the orientation decided by the source string orientation deciding section 23.

[Flow of Translation Processing]

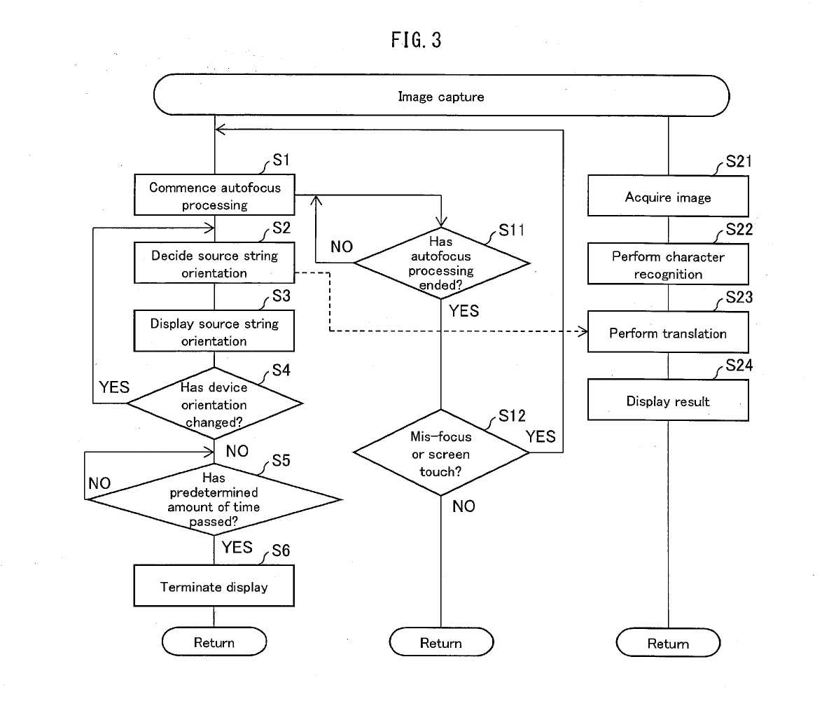

The following description will discuss, with reference to FIG. 3, how the mobile device 1 translates. FIG. 3 is a flow chart showing how the mobile device 1 translates a character string. As shown in FIG. 3, in a case where image capture begins, the autofocus processing section 22 begins autofocus processing (S1) and, concurrently, the image acquisition section 21 acquires an image (S21).

In response to the commencement of the autofocus processing, the source string orientation deciding section 23 decides the source string orientation (S2), and the source string orientation display control section then controls the display section 16 to display information (source string orientation information) indicating the source string orientation thus decided (S3). Subsequently, in a case where the orientation of the mobile device 1 has changed (S4, “YES”), the source string orientation deciding section 23 decides a source string orientation in accordance with a changed orientation of the mobile device 1. The source string orientation display control section 24 then controls the display section 16 to display source string orientation information indicating the source string orientation thus decided. In contrast, in a case where the orientation of the mobile device 1 does not change (S4, “NO”) and a predetermined amount of time passes (S5, “YES”), the source string orientation display control section 24 controls the display section 16 to terminate displaying of the source string orientation information (S6).

Meanwhile, the character recognition section 25 recognizes a character string contained in the image which is acquired by the image acquisition section 21 (S22). The translation section 26 then translates a recognized result of which is notified by the character recognition section 25 on the premise that the character string is lined up in the source string orientation decided by the character string orientation deciding section 23 (S23). The source string orientation display control section 24 controls the display section 16 to display a translated result (S24).

After autofocus processing ends (S11, “YES”), in a case of detecting (i) the image capture section 12 being not in focus or (ii) a touch of the touch panel 11 (S12, “YES”), step S1 (the autofocus processing) is again proceeded with. Conversely, in a case of detecting (a) the image capture section 12 being in focus and (b) no touch of the touch panel 11 (S12, “NO”), the mobile device 1 simply returns to image capture.

Note that the display of source string orientation in step S3 is unrelated to termination of the autofocus processing in step S11. The source string orientation is displayed regardless of whether or not the autofocus processing has ended (whether or not the image capture section 12 is in focus).

### Embodiment 2

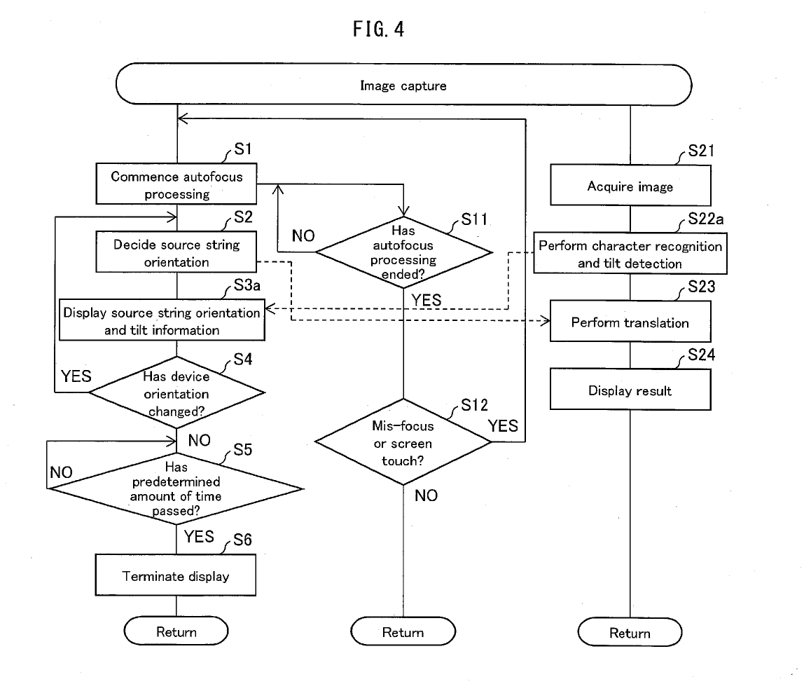

The following description will discuss Embodiment of the present invention with reference to FIG. 4. Embodiment 2 differs from Embodiment 1 in that information indicating that a subject of image capture is tilted is displayed. Here, “tilted” refers to a state in which the subject (for example, a book on which a character, etc., is printed) is not perpendicular (or substantially perpendicular) to a direction in which a mobile device 1 is pointing when capturing an image.

In a case where the subject is tilted, a character appearing on the subject will be at an angle during image capture. This causes a decrease in accuracy of character recognition. This ultimately causes a subsequent translation result to no longer be correct. Thus, notifying the user of the subject being tilted makes it possible to guarantee accuracy of translation.

In Embodiment 2, tilt of the subject is found based on a result of character recognition by a character recognition section 25. In a case where the tilt exceeds a predetermined angle, a source string orientation display control section 24 is notified of such. In a case where the character recognition section 25 notifies the source string orientation display control section 24 of the tilt exceeding the predetermined angle, the source string orientation display control section 24 controls a display section 16 to display differently such as (i) to change the color of an icon 101 to be displayed or (ii) to cause the icon 101 to blink. For example, in a case where the tilt does not exceed the predetermined angle, the color of the icon 101 is changed to be white, and in a case where the level of tilt does exceed the predetermined angle, the color of the icon 101 is changed to be red. Or, alternatively, in a case where the level of tilt does not exceed the predetermined angle, the color of the icon 101 is remained, and in a case where the level of tilt does exceed the predetermined angle, the icon 101 is caused to blink. Note also that the depth of color of the icon 101 or the cycle of blinking of the icon 101 can be changed in accordance with tilt.

Note that because techniques for detecting the tilt of a subject during the character recognition are well known, explanation of such is omitted here.

Here, the following description will discuss how a character string is translated in Embodiment 2, with reference to FIG. 4. FIG. 4 differs, in step 3 and step S22, from FIG. 3 of Embodiment 1. The step 22 (character recognition processing) in FIG. 3 is replaced, in Embodiment 2, by a step 22a (character recognition processing and tilt discernment). Furthermore, the step (displaying source string orientation) in FIG. 3 is replaced, in Embodiment 2, by a step 3a (displaying source string orientation and tilt information).

### Embodiment 3

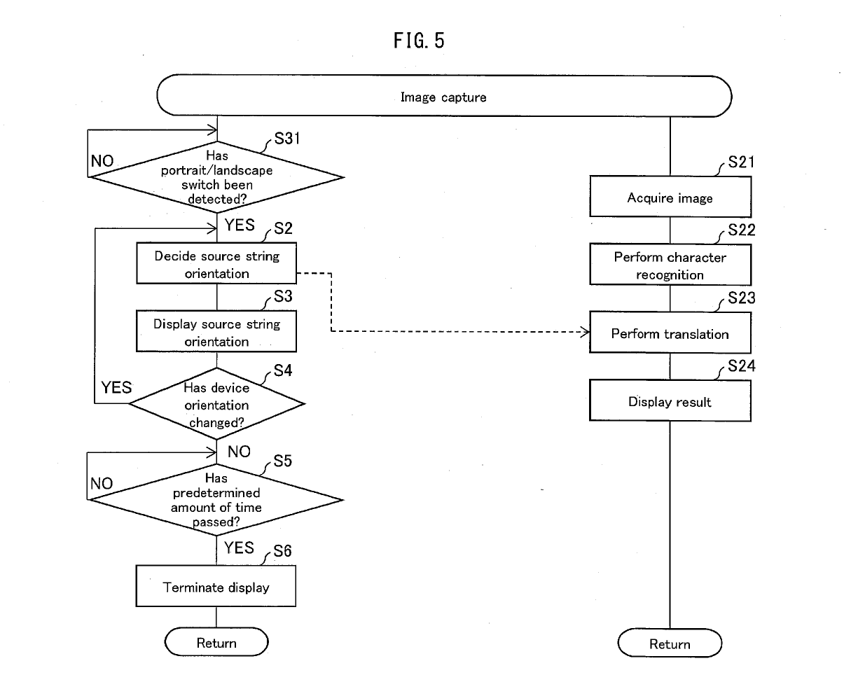

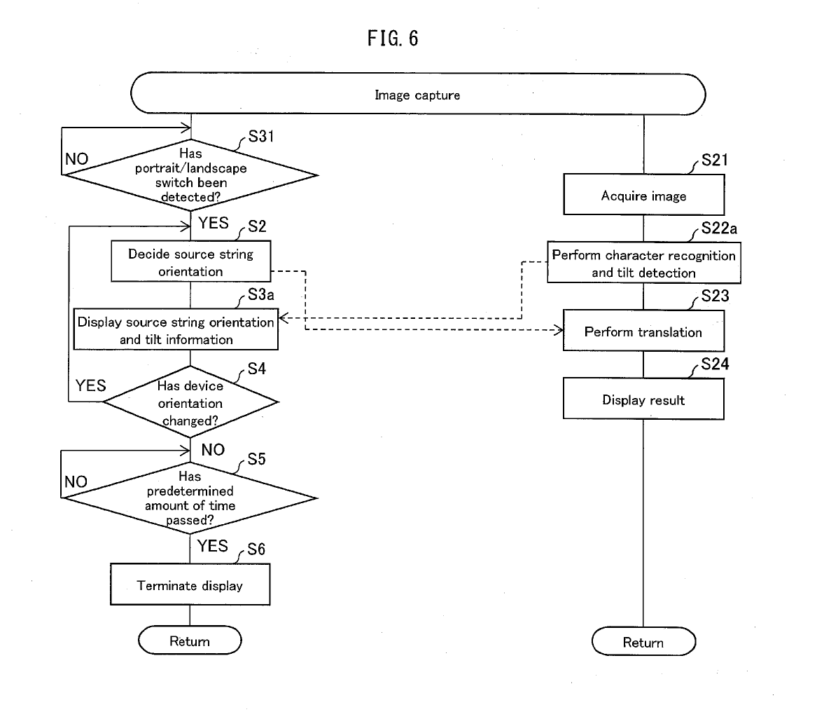

Here, Embodiment 3 of the present invention is discussed with reference to FIGS. 5 and 6. Embodiment 3 differs, from Embodiments 1 and 2, in the timing when the icon 101 is displayed. In Embodiments 1 and 2, the source string orientation is decided and the icon 101 is displayed once autofocus processing has commenced. In Embodiment 3, however, the source string orientation is decided and the icon 101 is displayed in a case where an orientation detection section 13 detects an orientation of the mobile device 1 and the orientation of the mobile device has changed, i.e., a screen, displayed by the mobile device, has switched from a portrait-orientation screen to a landscape-orientation screen or vice versa.

FIG. 5 is a flowchart showing how a change in the orientation of the mobile device 1 is detected, instead of the autofocus processing of Embodiment 1. In Embodiment 3, step S2 is proceeded with in a case where there is a detection, in step S31, of a change in orientation (S31, “YES”). This detection takes the place of commencement of autofocus processing (step S1 of FIG. 2).

FIG. 6 is a flowchart showing how a change in the orientation of the mobile device 1 is detected, instead of the autofocus processing of Embodiment 2. In Embodiment 3, step S2 is proceeded with in a case where there is a detection of a change in orientation (S31, “YES”). This detection takes the place of commencement of autofocus processing (step S1 of FIG. 3).

[Other]

The discussions of Embodiments 1 through 3 assume a language (for example, English) in which a character string runs horizontally. Note, however, that the language to be translated is not limited to such. Namely, Embodiments 1 through 3 can be applied to a language in which a character string runs vertically. In particular, according to each of Embodiments 1 through 3 in accordance with the present invention, the icon 101 clearly displays both an orientation of a character to be translated and an orientation of a character string to be translated. As such, Embodiments 1 through 3 are more effective in a case where a character string is not limited to being horizontal. This is because the orientation of the mobile device 1 indicates only the orientation of a character and not information about whether a character string written horizontally or vertically. This causes the user to have a difficulty in determining in which orientation a character string is to be translated.

A case to which the mobile device 1 in accordance with the above-described Embodiments 1 through 3 can be applied is as follows. For example, in a case where a character string is translated by the mobile device 1, the user keeps close watch on the character string to be translated. As such, it is possible that information displayed in a corner of the display section 16 will not be noticed by the user. Ordinary people have a tendency to adjust the mobile device 1 (a position of a camera (image capture section 12)) so that the character string to be translated appears, as much as possible, in or near the center of the display section 16.

As another example, assume a case where a character string to be translated appears on a book, etc., and the book, etc., is resting parallel to the horizon on a desk, etc. In such a case, the mobile device 1, when capturing an image of the character string, also becomes nearly horizontal. As such, it is highly likely that the screen of the mobile device 1 will frequently switch between a portrait-orientation screen and a landscape-orientation screen. It therefore becomes difficult for the user to determine whether the screen of the mobile device 1 has a portrait orientation or a landscape orientation. This results in the possibility that the screen of the mobile device 1 has an orientation differing from that intended by the user. Under such circumstances, in a case where the character string could not be appropriately translated, the user is unable to find out the reason for such and therefore becomes confused.

Even under such circumstances, according to Embodiments 1 through 3, information indicating the source string orientation (icon 101) is displayed at a position such that it is highly likely that the information comes into the user's view. This enables the user to easily determine whether the source string orientation differs from the orientation of the character string to be translated. It thus becomes possible to prevent circumstances where a difference between the source string orientation and the orientation of the character string intended for translation causes (i) a failure to appropriately translate a character string and (ii) the user to be confused.

Note that although Embodiments 1 through 3 each discuss a mobile device 1 that translates one language to another, they can also be applied to, for example, a device that simply recognizes a character or a device that carries out various types of searches after character recognition.

[Example Realized by Software]

A control block (especially the image acquisition section 21, the autofocus processing section 22, the source string orientation deciding section 23, and the source string orientation display control section 24) of the mobile device 1 can be realized by a logic circuit (hardware) provided in an integrated circuit (IC chip) or the like or can be alternatively realized by software as executed by a central processing unit (CPU).

In the latter case, the mobile device 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Overview]

A translation device according to a first aspect of the present invention is a translation device (mobile device) for (i) recognizing a character contained in a captured image, (ii) translating one or more recognized characters, and (iii) displaying a translation on a display section, the translation device including: a source string orientation deciding section for deciding a source string orientation, the source string orientation being an orientation of a character string to be translated; a source string orientation display control section for controlling the display section to display source string orientation information indicating the source string orientation decided by the source string orientation deciding section; and a translation section for translating the one or more recognized characters as a character string having the source string orientation.

With the above configuration, the source string orientation is displayed on the display section, thereby allowing a user to be easily aware of the source string orientation.

In a second aspect of the present invention, the translation device in accordance with the first aspect can be arranged such that the source string orientation display control section controls the display section to display the source string orientation information in (i) a position that overlaps with the character string to be translated, the character string to be translated being displayed on the display section, (ii) a position adjacent to the character string to be translated, or (iii) a center of the display section.

In general, in a case where some sort of information is displayed on the display section during image capture, the information is often displayed such that the information is, as much as possible, in a corner of the display section. This is done so as not to block a subject of image capture.

With the above configuration, however, the source string orientation information is displayed in (i) a position that overlaps with the character string to be translated, (ii) a position adjacent to the character string to be translated, or (iii) a center of the display section. This makes it possible to ensure that it is extremely likely that the user will be aware of the source string orientation information. This ultimately makes it possible to prevent a situation in which the user fails to notice the source string orientation information, is unable to determine the source string orientation, and subsequently becomes confused.

In a third aspect of the present invention, the translation device in accordance with the first or second aspect can be arranged such that the source string orientation display control section controls the display section to display the source string orientation information, in a case where (i) autofocusing has commenced in image capture processing by the translation device or (ii) a screen displayed on the display section switches from a portrait-orientation screen to a landscape-orientation screen or vice versa, the display section being rectangular and having a long side and a short side, the portrait-orientation screen being displayed in a case where the long side of the display section is closer to vertical than is the short side of the display section, the landscape-orientation screen being displayed in a case where the short side of the display section is closer to vertical than is the long side of the display section.

In a case where autofocus has commenced, or in a case where a device switches from a portrait-orientation screen to a landscape-orientation screen or vice versa, it is highly likely that the user is performing some operation of the device. Thus, with the above configuration, it becomes possible to display the source string orientation information in a case where it is highly likely that the user is performing some operation of the device, i.e., in a case where it is highly likely that the user is looking at the device.

In a fourth aspect of the present invention, the translation device in accordance with any of the first through third aspects can be arranged such that after a predetermined amount of time has passed, the source string orientation display control section controls the display section to terminate display of the source string orientation information being displayed on the display section.

With the above configuration, display of the source string orientation information on the display section is terminated after a predetermined amount of time has passed. This makes is possible to prevent a situation in which continuous display of the source string orientation information makes it difficult for the user to see a character string to be translated or a translation result. Note that the “predetermined amount of time” is an amount of time for which the user will not feel distracted by the icon. The predetermined amount of time can be, for example, approximately 1 second (0.5 seconds to 1.5 seconds).

In a fifth aspect of the present invention, the translation device in accordance with any of the first through fourth aspects can be arranged such that: the translation device further comprises a subject angle determination section for determining whether or not an angle formed by (i) a subject of image capture and (ii) a plane perpendicular to an image capture direction has exceeded a predetermined value; and, in a case where the subject angle determination section determines that the angle has exceeded the predetermined value, the source string orientation display control section controls the display section to display (i) the source string orientation information and (ii) information indicating that the angle has exceeded the predetermined value.

In general, in a case where the angle formed by (i) the subject of image capture and (ii) a plane perpendicular to the image capture direction becomes greater than a certain value, it becomes difficult to accurately recognize a character. Inaccuracy of character recognition causes the translation processing to become inaccurate as well. With the above configuration, in a case where the angle formed by (i) the subject of image capture and (ii) a plane perpendicular to the image capture direction becomes exceeds a predetermined value, information indicating that the angle has exceeded the predetermined value is displayed along with the source string orientation information. This makes it possible to inform the user that the angle of the subject is not suitable. This ultimately makes it possible to prevent inaccurate translation. Note that the “image capture direction” refers to a direction which the image capture section is facing during image capture (a direction in which the camera is pointed).

In a sixth aspect of the present invention, a control method of a translation device is a method for controlling a translation device, the translation device being for (i) recognizing a character contained in a captured image, (ii) translating one or more recognized characters, and (iii) displaying a translation on a display section, the method including the steps of: (a) deciding a source string orientation, the source string orientation being an orientation of a character string to be translated; (b) controlling the display section to display source string orientation information indicating the source string orientation decided in the step (a); and (c) translating the one or more recognized characters as a character string having the source string orientation.

This brings about the same advantageous effect as the first aspect.

The translation device in accordance with each aspect of the present invention may be realized by a computer. In such a case, the present invention encompasses: a control program for the translation device which program causes a computer to operate as each section of the translation device so that the translation device can be realized by the computer; and a computer-readable storage medium storing therein the control program.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention can be utilized in a mobile device having a translation function.

### REFERENCE SIGNS LIST

1 Mobile device (translation device)
21 Image acquisition section
22 Autofocus processing section
23 Source string orientation deciding section
24 Source string orientation display control section
25 Character recognition section (subject angle determination section)
26 Translation section
101 Icon (source string orientation information)

1: A translation device for (i) recognizing a character contained in a captured image, (ii) translating one or more recognized characters, and (iii) displaying a translation on a display section, the translation device comprising:
a source string orientation deciding section for deciding a source string orientation, the source string orientation being an orientation of a character string to be translated;
a source string orientation display control section for controlling the display section to display source string orientation information indicating the source string orientation decided by the source string orientation deciding section; and
a translation section for translating the one or more recognized characters as a character string having the source string orientation.

2: The translation device according to claim 1, wherein the source string orientation display control section controls the display section to display the source string orientation information in (i) a position that overlaps with the character string to be translated, the character string to be translated being displayed on the display section, (ii) a position adjacent to the character string to be translated, or (iii) a center of the display section.

3: The translation device according to claim 1, wherein the source string orientation display control section controls the display section to display the source string orientation information, in a case where (i) autofocusing has commenced in image capture processing by the translation device or (ii) a screen displayed on the display section switches from a portrait-orientation screen to a landscape-orientation screen or vice versa, the display section being rectangular and having a long side and a short side, the portrait-orientation screen being displayed in a case where the long side of the display section is closer to vertical than is the short side of the display section, the landscape-orientation screen being displayed in a case where the short side of the display section is closer to vertical than is the long side of the display section.

4: The translation device according to claim 1, wherein, after a predetermined amount of time has passed, the source string orientation display control section controls the display section to terminate display of the source string orientation information being displayed on the display section.

5: A translation device according to claim 1, further comprising:
a subject angle determination section for determining whether or not an angle formed by (i) a subject of image capture and (ii) a plane perpendicular to an image capture direction has exceeded a predetermined value,
wherein, in a case where the subject angle determination section determines that the angle has exceeded the predetermined value, the source string orientation display control section controls the display section to display (i) the source string orientation information and (ii) information indicating that the angle has exceeded the predetermined value.
